(19) United States
(12) Patent Application Publication
(10) Pub. No.: US 2026/0310210 A1
(43) Pub. Date: Oct. 8, 2026

(54) INFORMATION PROCESSING APPARATUS, INFORMATION PROCESSING METHOD, AND PROGRAM

(71) Applicant: Sony Group Corporation, Tokyo (JP)

(72) Inventors: Tomohito ODA, Tokyo (JP); IshwarPrakash HEBBAR, Tokyo (JP)

(73) Assignee: Sony Group Corporation, Tokyo (JP)

(21) Appl. No.: 19/122,268

(22) PCT Filed: Sep. 19, 2023
(86) PCT No.: PCT/JP2023/033929

§ 371 Date: Apr. 18, 2025

(30) Foreign Application Priority Data
Oct. 28, 2022 (JP) 2022-173054

(51) Int. Cl. G05D 1/495; G05D 1/246; G05D 1/65; G05D 107/13; G05D 109/10; G05D 111/10; H04N 23/68

(52) U.S. Cl. CPC G05D 1/495; G05D 1/246; G05D 1/65; H04N 23/6811; G05D 2107/13; G05D 2109/10; G05D 2111/10

(57) ABSTRACT

Vibration generated in a camera mounted on a mobile body is to be damped more efficiently. An information processing apparatus includes: an acquisition unit that acquires vibration information regarding vibration generated in a camera mounted on a mobile body, the vibration information being based on a video image captured by imaging performed by the camera; and a generation unit that generates control information to be used for damping the vibration, on the basis of the vibration information acquired by the acquisition unit.

### TECHNICAL FIELD

The present disclosure relates to an information processing apparatus, an information processing method, and a program.

### BACKGROUND ART

In recent years, there have been developed techniques by which a camera is attached to a mobile body such as an automobile, an autonomous mobile carriage, or a drone, and the mobile body is used for imaging. For example, Patent Document 1 discloses a technique by which a sensor detects shake of a camera mounted on a mobile body, and a control value based on the detected shake of the camera is fed back to a motor to control the shake of the camera.

### CITATION LIST

### Patent Document

Patent Document 1: Japanese Patent Application Laid-Open No. 2019-092017

### SUMMARY OF THE INVENTION

### Problems to be Solved by the Invention

In Patent Document 1, however, when the acceleration or the frequency of vibration generated in a mobile body increases by a certain amount or more, for example, it might be difficult to reduce the shake of the camera. As a means for damping high-frequency vibration, a passive vibration damping mechanism including a wire, a spring damper system, or the like can be used. However, while a vibration damping effect is achieved in a high-frequency region, there also is a region in which vibration is increased due to resonance in a low-frequency region. Further, in Patent Document 1, shake is detected by a sensor. However, there are cases where the tendency of shake to be detected by the sensor and the tendency of shake of an actual video image do not match due to the influence of camera shake correction, the distance to the subject, and the like.

Therefore, the present disclosure proposes a novel and improved information processing apparatus, information processing method, and program capable of more efficiently damping vibration generated in a camera mounted on a mobile body.

### Solutions to Problems

The present disclosure provides an information processing apparatus that includes: an acquisition unit that acquires vibration information regarding vibration generated in a camera mounted on a mobile body, the vibration information being based on a video image captured by imaging performed by the camera; and a generation unit that generates control information to be used for damping the vibration, on the basis of the vibration information acquired by the acquisition unit.

Also, the present disclosure provides an information processing method that is implemented by a computer, and includes: acquiring vibration information regarding vibration generated in a camera mounted on a mobile body, the vibration information being based on a video image captured by imaging performed by the camera; and generating control information to be used for damping the vibration, on the basis of the acquired vibration information.

Further, the present disclosure provides a program for causing a computer to implement: an acquisition function to acquire vibration information regarding vibration generated in a camera mounted on a mobile body, the vibration information being based on a video image captured by imaging performed by the camera; and a generation function to generate control information to be used for damping the vibration, on the basis of the vibration information acquired by the acquisition function.

### BRIEF DESCRIPTION OF DRAWINGS

FIG. 1 is an explanatory diagram for explaining an example of an information processing system according to the present disclosure.

FIG. 2 is an explanatory diagram for explaining an example of the functional configuration of a vehicle according to the present disclosure.

FIG. 3 is an explanatory diagram for explaining an overview of vibration information acquisition.

FIG. 4 is an explanatory diagram for explaining an example of a graph illustrating the relationship between the magnitude of amplitude and frequency obtained by an analysis unit.

FIG. 5 is an explanatory diagram for explaining an example of control information indicating a moving route.

FIG. 6 is an explanatory diagram for explaining an example of an operation process to be performed by the information processing apparatus according to the present embodiment.

FIG. 7A is an explanatory diagram for explaining a specific example of the shape of the wheels of the vehicle.

FIG. 7B is an explanatory diagram for explaining a specific example of the shape of the wheels of the vehicle.

FIG. 7C is an explanatory diagram for explaining a specific example of the shape of the wheels of the vehicle.

FIG. 8A is an explanatory diagram for explaining a specific example of the shape of a road surface in an environment in which the vehicle moves.

FIG. 8B is an explanatory diagram for explaining a specific example of the shape of a road surface in an environment in which the vehicle moves.

FIG. 9 is a block diagram showing the hardware configuration of the information processing apparatus.

### MODE FOR CARRYING OUT THE INVENTION

A preferred embodiment of the present disclosure will be described below in detail, with reference to the accompanying drawings. Note that, in the present specification and drawings, components having substantially the same functional configuration are denoted by the same reference signs, and repetitive explanations are not made.

Further, the “mode for carrying out the disclosure” is described according to the order of items shown below.
1. Outline
1.1. Outline of an information processing system
1.2. Example functional configuration of a vehicle
2. Examples
2.1. Overview
2.2. Example of vibration analysis
2.3. First example
2.4. Second example
2.5. Third example
3. Example of an operation process
4. Modifications
5. Example of a hardware configuration
6. Supplementary notes

### 1. Outline

As an embodiment of the present disclosure, a mechanism for more efficiently reducing vibration generated in a camera mounted on a mobile body is now described.

### <1.1. Outline of an Information Processing System>

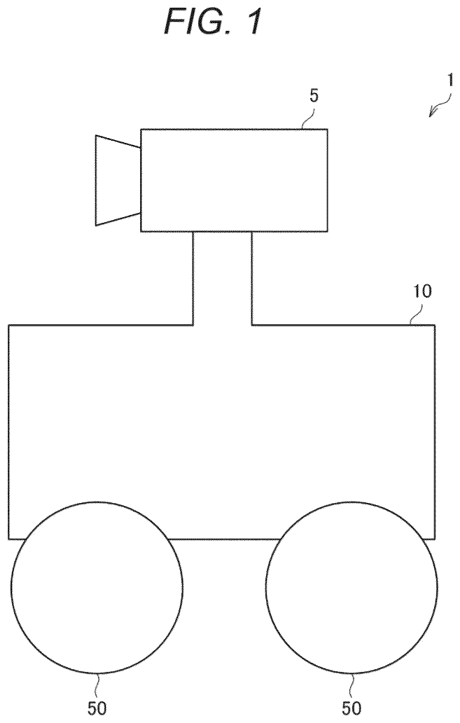

FIG. 1 is an explanatory diagram for explaining an example of an information processing system according to the present disclosure. The information processing system according to the present disclosure includes a vehicle 1.

### (Vehicle 1)

The vehicle 1 according to the present disclosure is an example of a mobile body that moves while capturing an image of a certain environment. In a case where the vehicle 1 is used for the purpose of monitoring the inside of a factory, for example, the vehicle 1 moves while imaging the inside of the factory. Also, the vehicle 1 may move while imaging the inside of the factory beforehand to acquire the later-described frequency response information, prior to an actual operation of monitoring in the factory.

The vehicle 1 is an unmanned mobile body that moves autonomously. For example, the vehicle 1 may autonomously move on the basis of input information such as the positions of the two points of the start point and the end point. Also, the input information to be used for autonomous control on the vehicle 1 may include information regarding the moving route.

Note that the unmanned mobile body is not limited to the vehicle 1. The unmanned mobile body may be a ship, for example, or may be a flying object such as a drone.

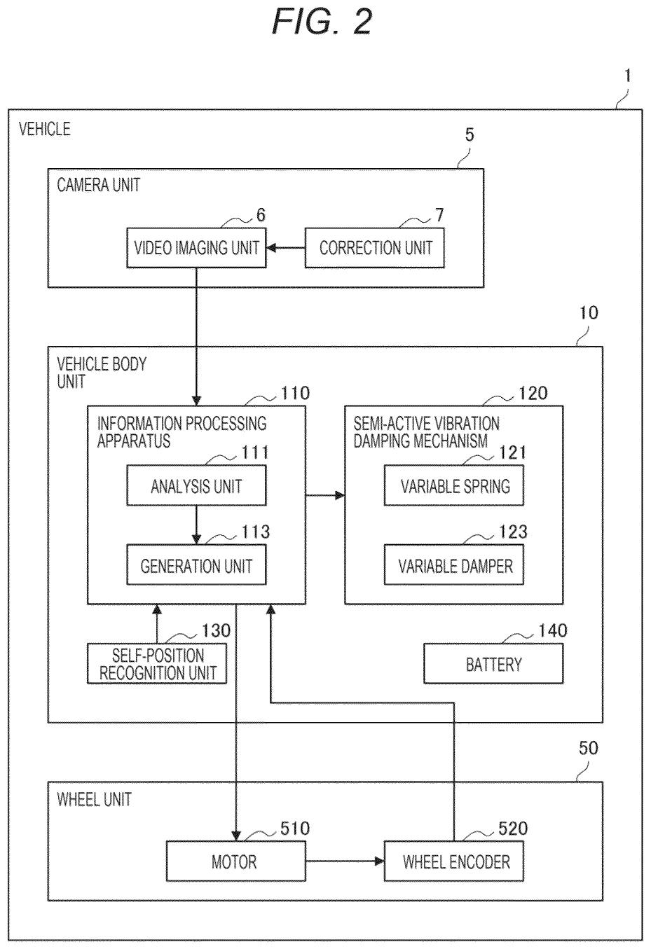

Further, the vehicle 1 according to the present disclosure includes a camera unit 5, a vehicle body unit 10, and a wheel unit 50. In the description below, an example of a functional configuration of the vehicle 1 is explained with reference to FIG. 2.

### <1.2. Example Functional Configuration of the Vehicle 1>

FIG. 2 is an explanatory diagram for explaining an example functional configuration of the vehicle 1 according to the present disclosure.

### (Camera Unit 5)

The camera unit 5 according to the present disclosure acquires a video image of an environment in which the vehicle 1 moves. Vibration generated in the wheel unit 50 is transferred from the vehicle body unit 10 to the camera unit 5.

As shown in FIG. 2, the camera unit 5 according to the present disclosure includes a video imaging unit 6 and a correction unit 7.

The video imaging unit 6 according to the present disclosure has a video acquisition function of acquiring a video image by imaging. Also, the video imaging unit 6 outputs the video image acquired by imaging to the information processing apparatus 110 described later.

The correction unit 7 according to the present disclosure has a correction function of correcting blurring of the video image captured by the video imaging unit 6. The correction function may be implemented by performing a known correction process. For example, the known correction process includes a process related to camera shake correction included in a commercially available camera.

### (Vehicle Body Unit 10)

The vehicle body unit 10 according to the present disclosure is the vehicle body portion of the vehicle 1, and transfers vibration input from the wheel unit 50 to the camera unit 5. As shown in FIG. 2, the vehicle body unit 10 includes the information processing apparatus 110, a semi-active vibration damping mechanism 120, a self-position recognition unit 130, and a battery 140.

The information processing apparatus 110 according to the present disclosure acquires vibration information regarding the vibration generated in the camera unit 5 on the basis of a video image obtained by imaging performed by the camera unit 5, and generates control information to be used for damping the vibration on the basis of the vibration information.

As shown in FIG. 2, the information processing apparatus 110 includes an analysis unit 111 and a generation unit 113.

The analysis unit 111 according to the present disclosure is an example of the acquisition unit, analyzes the video image input from the camera unit 5, and acquires the vibration information regarding the vibration generated in the camera unit 5. Here, the vibration information includes various kinds of information such as information regarding the magnitude of the vibration and information regarding the frequency of the vibration. Also, the magnitude of the vibration may be the magnitude of amplitude, for example. A specific example regarding the video image analysis will be described later.

The generation unit 113 according to the present disclosure generates vibration information to be used for damping the vibration, on the basis of the vibration information obtained by the analysis unit 111.

The generation unit 113 generates control information to be used for damping the vibration, on the basis of the fact that the magnitude of the vibration does not satisfy a predetermined standard. For example, when the magnitude of the amplitude is equal to or greater than a predetermined value, the generation unit 113 may determine that the magnitude of the vibration does not satisfy a predetermined standard, and generate control information to be used for damping the vibration. Specific examples of control information to be used for vibration damping will be described later.

The semi-active vibration damping mechanism 120 according to the present disclosure is a vibration damping mechanism capable of changing characteristics such as elastic force or resistance force. As the characteristics of the semi-active vibration damping mechanism 120 are changed, the resonance region is also changed. For example, vibration generated in the wheel unit 50 is transferred to the camera unit 5 via the semi-active vibration damping mechanism 120. Here, the magnitude of the vibration to be transferred to the camera unit 5 changes depending on the characteristics of the semi-active vibration damping mechanism 120.

The semi-active vibration damping mechanism 120 may change its characteristics on the basis of the control information generated by the generation unit 113, for example.

As shown in FIG. 2, the semi-active vibration damping mechanism 120 includes a variable spring 121 and a variable damper 123.

The variable spring 121 according to the present disclosure is a spring having a variable elastic force. As the elastic force of the variable spring 121 is changed, the frequency corresponding to the resonance frequency can be moved. For example, the elastic force of the variable spring 121 may be changed on the basis of the control information generated by the generation unit 113. Further, the variable spring 121 is not limited to any particular kind, but may be an air spring, for example.

The variable damper 123 according to the present disclosure is a damper having a variable resistance force. As the resistance force of the variable damper 123 is changed, the magnitude of the amplitude corresponding to the resonance frequency can be reduced. For example, the resistance force of the variable spring may be changed on the basis of the control information generated by the generation unit 113. Further, the variable damper 123 is not limited to any particular kind, but may be a magnetic fluid damper, for example.

The self-position recognition unit 130 according to the present disclosure recognizes the position of the vehicle 1. For example, the functions of the self-position recognition unit 130 are implemented by a sensor capable of acquiring information regarding the self-position of the vehicle 1.

For example, the self-position recognition unit 130 may recognize the position of the vehicle 1 with a positioning device sensor (LiDAR), or may recognize the position of the vehicle 1 with a global navigation satellite system (GNSS).

The battery 140 according to the present disclosure can accumulate (or charge) and release (or discharge) electric power using a chemical reaction, and supplies the accumulated electric power as a power supply for each component included in the vehicle 1. The battery 140 may be any battery such as a lithium ion secondary battery, a nickel-cadmium storage battery, or a lead-acid battery, for example.

### (Wheel Unit 50)

The wheel unit 50 according to the present disclosure includes wheels that move the vehicle 1 by coming into contact with a road surface, and is a generation source of vibration to be generated in the camera unit 5. As shown in FIG. 2, the wheel unit 50 includes a motor 510 and a wheel encoder 520.

The motor 510 according to the present disclosure drives the wheels of the vehicle 1 with the electric power input from the battery 140. For example, the motor 510 drives the wheels of the vehicle 1, on the basis of the control information generated by the generation unit 113.

The wheel encoder 520 according to the present disclosure acquires wheel speed information including a vehicle speed pulse of the wheels of the vehicle 1. The wheel encoder 520 outputs the acquired wheel speed information to the information processing apparatus 110.

An example of the functional configuration of the vehicle 1 according to the present disclosure has been described so far. In the following, examples of the information processing system according to the present disclosure are described.

### 2. Examples

### <2.1. Overview>

These days, there are increasing cases where a camera is mounted on a mobile body so that the mobile body is used for imaging. However, there are cases where vibration generated while the mobile body is moving has influence, such as blurring, on a video image obtained by the camera.

Various methods are used to reduce such blurring of video images. For example, there is a method using camera shake correction, which is one function of a camera, as a method for reducing blurring of a video image. However, camera shake correction is designed on the premise of human camera shake, and it is difficult to damp high-frequency vibration, for example. Also, there are cases where performance related to reduction of blurring varies with each camera mounted on a mobile body. Therefore, the administrator of the mobile body might need to verify the performance related to reduction of blurring for each camera mounted on the mobile body.

Further, as another method for reducing blurring of a video image, there is a method by which a passive vibration damping mechanism is mounted on a mobile body. There is a plurality of types of passive vibration damping mechanisms such as suspension types, spring damper types, and wire types, for example. However, since there are a resonance region and a vibration damping region in any type of passive damping mechanism, it is difficult to uniformly damp the frequencies of all vibration. Furthermore, since the resonance frequency also varies depending on the weight of the mounted camera and the camera shake correction performance, work such as replacement and adjustment of vibration damping components such as springs and wires might be required every time the camera is changed.

Further, the vibration to be input to the vehicle body changes with various kinds of information such as the road surface on which the mobile body is moving, the type of the wheels of the mobile body, the speed of the mobile body, or the posture of the vehicle body or the camera. Therefore, the damping performance required for reducing blurring of video images changes depending on the traveling environment of the mobile body and the features of the mobile body. Therefore, work such as replacement or adjustment of vibration damping components by the administrator might be required depending on the required damping performance.

As described above, by the method for reducing blurring of a video image as described above, when a component (a camera, wheels, or the like) of the mobile body, the environment in which the mobile body is moving, or the like is changed, the administrator of the mobile body needs to verify the vibration damping performance each time, and work such as replacement or adjustment of the vibration damping component may be required as necessary.

In view of this, the information processing apparatus 110 according to the present disclosure acquires information about the vibration generated in the camera unit 5 mounted on the vehicle 1 on the basis of a video image obtained by imaging performed by the camera unit 5, and generates control information to be used for damping the vibration on the basis of the vibration information. Thus, it is possible to reduce the trouble of the work required for vibration damping as described above, and the information processing apparatus 110 can more efficiently damp the vibration generated in the camera unit 5.

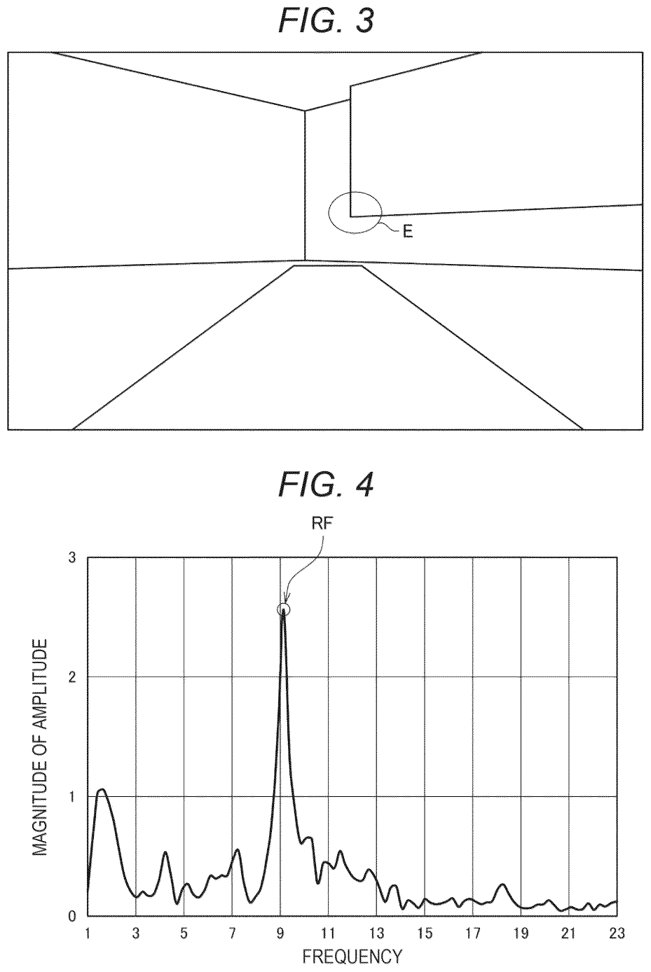

Referring first to FIGS. 3 and 4, a specific example of a method implemented by the analysis unit 111 according to the present disclosure to acquire vibration information is described.

### <2.2. Example of Vibration Analysis>

FIG. 3 is an explanatory diagram for explaining an overview of vibration information acquisition. FIG. 3 is an example of a video image obtained by imaging performed by the camera unit 5 included in the vehicle 1. Further, the video image shown in FIG. 3 is a video image in which there is a wall at the end of the passage in which the vehicle 1 is moving, and a screen is put on the wall.

First, the vehicle 1 moves while performing imaging in a certain environment. The analysis unit 111 then extracts an edge E from the video image, using a known method. For example, in the example illustrated in FIG. 3, the analysis unit 111 extracts the edge E present at the lower left corner of the screen from the video image, using a known method.

Note that the method for extracting the edge E is not limited to any particular method, but the method for extracting the edge E may be a method using various filters such as a Sobel filter or a Laplacian filter, for example.

Subsequently, the analysis unit 111 observes the movement of the extracted edge E, and acquires vibration information including the amplitude and the frequency. For example, the analysis unit 111 may acquire vibration information by analyzing the vibration component by performing fast Fourier transform (FFT) on the movement of the edge E. Also, the analysis unit 111 acquires the relationship between the magnitude of the amplitude and the frequency in the environment, on the basis of the analysis result.

FIG. 4 is an explanatory diagram for explaining an example of a graph illustrating the relationship between the magnitude of the amplitude and the frequency obtained by the analysis unit 111. In the graph shown in FIG. 4, the horizontal axis indicates frequency, and the vertical axis indicates amplitude.

For example, the analysis unit 111 acquires a graph showing the relationship between the magnitude of the amplitude and the frequency as shown in FIG. 4, on the basis of the analysis result. The analysis unit 111 then identifies a dominant frequency (a resonance frequency, for example) for the vibration.

For example, in the graph shown in FIG. 4, a resonance frequency RF is present at approximately 9 Hz. The amplitude corresponding to the resonance frequency RF is greater than the amplitude corresponding to the other frequencies as shown in FIG. 4.

In other words, when the frequency of vibration generated in the camera unit 5 is approximately 9 Hz (resonance frequency RF), blurring of the video image obtained by imaging performed by the camera unit 5 is greater than that with the frequency (5 Hz or 15 Hz, for example) at which the frequency of vibration is not the resonance frequency RF. That is, to reduce blurring of the video image, it is desirable that the generation unit 113 generate control information for setting the frequency of vibration at a frequency away from the frequency band of the resonance frequency RF.

Note that the allowable range of blurring of the video image might vary depending on the purpose of use of the video image. For example, in a case where the purpose of use of the video image is to provide the administrator who monitors the inside of the factory with the video image, the magnitude of vibration that does not cause a feeling of strangeness in the administrator who performs the monitoring with the video image may be set as the allowable range of blurring of the video image.

As a more specific example, the magnitude of the amplitude with which a human can perceive the object included in the video image may be set as the allowable range, for example. In a case where the magnitude of the amplitude set as the allowable range is set to a predetermined value, the generation unit 113 may regard that a human has a feeling of strangeness about the video image when the magnitude of the amplitude becomes equal to or larger than the predetermined value, and generate control information for damping the vibration. Note that the predetermined value may be experimentally obtained, or may be manually set by the user.

A specific example in which the analysis unit 111 according to the present disclosure acquires vibration information has been described so far. Next, specific examples in which the generation unit 113 according to the present disclosure generates control information to be used for vibration damping on the basis of the vibration information are described.

Note that, in the following description, three types of examples are explained as the control information to be used for vibration damping. The control information according to a first example is control information for changing the speed of the vehicle 1, the control information according to a second example is control information for changing the characteristics of the semi-active vibration damping mechanism 120, and the control information according to a third example is control information indicating the moving route of the vehicle 1. The generation unit 113 according to the present disclosure may perform one of the processes to be described in the first to third examples, or may execute a process that is a combination of a plurality of the examples.

Also, in the following description, the vehicle 1 moves in an environment prior to practical use, and the analysis unit 111 acquires the above-described relationship between the magnitude of the amplitude and the frequency (this relationship will be expressed as frequency response information in some cases in the following description). Further, examples in which the generation unit 113 generates various kinds of control information on the basis of frequency response information acquired beforehand and vibration information (amplitude, frequency, and the like) acquired in real time are mainly described.

### <2.3. First Example>

Normally, the frequency of the vibration to be generated in the wheel unit 50 may become higher as the speed of the wheels of the vehicle 1 becomes higher. That is, as the speed of the wheels of the vehicle 1 is changed, the magnitude of the vibration to be transferred from the wheel unit 50 to the camera unit 5 via the vehicle body unit 10 can also be changed.

Therefore, when the magnitude of the amplitude is equal to or higher than a predetermined value (or when blurring outside the allowable range occurs), the generation unit 113 may generate control information for changing the speed of the vehicle 1.

For example, the generation unit 113 may generate control information for changing the speed of the vehicle 1, on the basis of the frequency response information. In a case where the frequency response information as shown in FIG. 4 has been obtained, the magnitude of the amplitude generated in the camera unit 5 is the maximum at approximately 9 Hz, at which the resonance frequency RF is present.

That is, in a case where the frequency of the vibration generated in the camera unit 5 is 8.5 Hz, when the speed of the vehicle 1 is increased, the frequency approaches the resonance frequency RF shown in FIG. 4, and the amplitude becomes larger.

On the other hand, when the frequency of vibration drops from 8.5 Hz toward 8 Hz, the frequency becomes farther away from the resonance frequency RF shown in FIG. 4, and the amplitude becomes smaller.

Therefore, the generation unit 113 may generate control information for lowering the speed of the vehicle 1 so that the frequency of the vibration generated in the camera unit 5 becomes farther away from the resonance frequency RF.

Also, the generation unit 113 may generate control information for lowering the speed of the wheels of the vehicle 1 so that the magnitude of the amplitude becomes equal to or smaller than a predetermined value. More specifically, in a case where the predetermined value is the value of the magnitude of the amplitude corresponding to 8.5 Hz, the generation unit 113 may generate control information for lowering the speed of the wheels of the vehicle 1.

Further, as shown in FIG. 4, in a case where the frequency of the vibration generated in the camera unit 5 exceeds the resonance frequency RF (approximately 9 Hz) and becomes even higher, the amplitude can become smaller. Therefore, the generation unit 113 may generate control information for increasing the speed of the wheels of the vehicle 1 so that the magnitude of the amplitude becomes equal to or smaller than the predetermined value.

The information processing apparatus 110 then outputs the control information for changing the speed of the vehicle 1 to the motor 510 included in the wheel unit 50. Also, the motor 510 may drive the wheels and change the speed of the vehicle 1, on the basis of the input control information.

According to the first example described so far, the speed of the vehicle 1 is changed, so that the magnitude of the amplitude generated in the camera unit 5 is changed, and thus, blurring of the video image can be reduced.

Note that the control information according to the first example is not limited to the above example. For example, the generation unit 113 may generate control information for changing the speed of the vehicle 1 so as to be out of a predetermined range from the resonance frequency RF. Here, the range outside the predetermined range includes the range in which the magnitude of the amplitude is smaller than the predetermined value.

### <2.4. Second Example>

The semi-active vibration damping mechanism 120 is a mechanism capable of changing characteristics such as elastic force or resistance force as described above. Also, since the vibration generated in the wheel unit 50 is transferred to the camera unit 5 via the semi-active vibration damping mechanism 120, the magnitude of the vibration to be transferred to the camera unit 5 changes depending on the characteristics of the semi-active vibration damping mechanism 120.

Therefore, the generation unit 113 may generate control information for changing the characteristics of the semi-active vibration damping mechanism 120 when the magnitude of the amplitude generated in the camera unit 5 is equal to or greater than a predetermined value.

The variable spring 121 has a variable elastic force. As the elastic force of the variable spring 121 changes, for example, the frequency corresponding to the resonance frequency shifts. More specifically, in a case where the resonance frequency RF is approximately 9 Hz as shown in FIG. 4, it is possible to increase the frequency corresponding to the resonance frequency RF to the 11 Hz side by increasing the elastic force of the variable spring 121, and it is possible to lower the frequency corresponding to the resonance frequency RF to the 8 Hz side by lowering the elastic force of the variable spring 121.

Therefore, the generation unit 113 may generate control information for changing the elastic force of the variable spring 121 when the magnitude of the amplitude generated in the camera unit 5 is equal to or greater than a predetermined value. For example, on the basis of the frequency response information, the generation unit 113 may generate control information for changing the elastic force of the variable spring 121 so that the magnitude of the amplitude becomes smaller than the predetermined value.

Also, the resistance force of the variable damper 123 is variable. For example, as the resistance force of the variable damper 123 changes, the magnitude of the amplitude corresponding to the resonance frequency shifts. More specifically, it is possible to reduce the amplitude corresponding to the resonance frequency RF by increasing the resistance force of the variable damper 123.

Therefore, the generation unit 113 may generate control information for changing the resistance force of the variable damper 123 when the magnitude of the amplitude generated in the camera unit 5 is equal to or greater than a predetermined value. For example, when the magnitude of the amplitude generated in the camera unit 5 is equal to or greater than the predetermined value, the generation unit 113 may generate control information for increasing the resistance force of the variable damper 123 on the basis of the frequency response information.

According to the second example described so far, the characteristics of the semi-active vibration damping mechanism 120 are changed, so that the frequency characteristics from the vibration input to the video image output can be corrected, and thus, blurring of the video image can be reduced.

### <2.5. Third Example>

In an environment where the vehicle 1 moves, both an area where vibration becomes greater (an area having many irregularities, for example) and an area where vibration becomes smaller (an area with fewer irregularities) might coexist in some cases.

In such a case, it is possible to reduce blurring of the video image by the vehicle 1 moving while avoiding the area where the vibration becomes greater. Therefore, the information processing apparatus 110 may acquire map information in which a magnitude of vibration is set for each area.

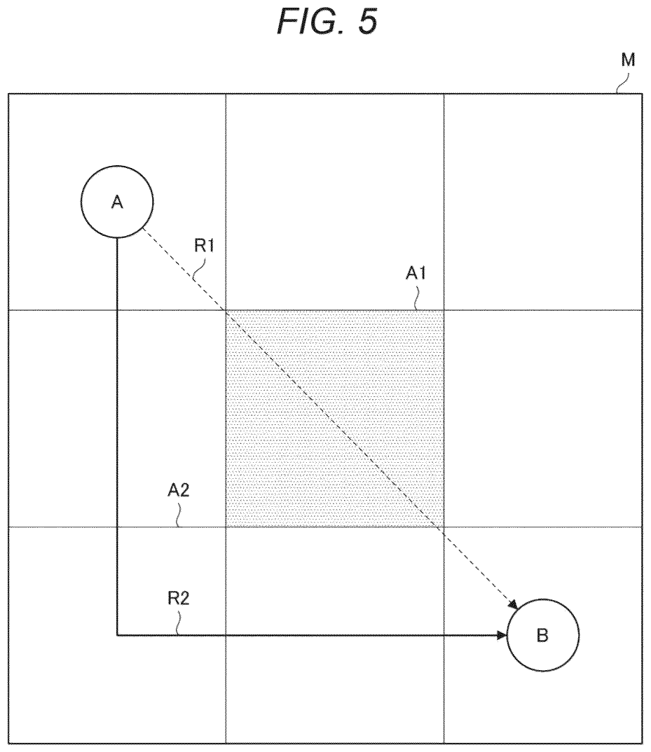

FIG. 5 is an explanatory diagram for explaining an example of control information indicating a moving route. For example, the information processing apparatus 110 acquires map information M including nine (3×3) areas as shown in FIG. 5 for the environment in which the vehicle 1 is moving. For example, the map information M includes an area A1 in which vibration becomes greater (an area emphasized with dots) and an area A2 in which vibration becomes smaller (an area without dots).

For example, in a case where the vehicle 1 moves from a point A to a point B, on a route R1 for traveling straight from the point A to the point B, the vehicle 1 passes through the area A1 in which vibration becomes greater, and therefore, blurring of the video image might be large.

On a route R2 for the vehicle 1 detouring from the point A to the point B, on the other hand, the vehicle 1 does not pass through the area A1 in which vibration becomes larger, and accordingly, blurring of the video image may be smaller than that on the route R1.

Therefore, the generation unit 113 may generate control information indicating a moving route of the vehicle 1, on the basis of the relationship between each area of the plurality of areas included in the map information of the environment in which vehicle 1 is moving and the magnitude of the vibration.

For example, the self-position recognition unit 130 may acquire location information regarding the self position of the vehicle 1, and output the location information to the information processing apparatus 110. The generation unit 113 may then associate the location information with the map information M, to generate control information indicating a moving route for avoiding the area in which large vibration occurs.

More specifically, the generation unit 113 may generate control information indicating a moving route in which the magnitude of the amplitude is smaller than a predetermined value.

Note that the map information M as shown in FIG. 5 may be prepared beforehand prior to the vehicle 1 is actually operated in an environment, or may be acquired in parallel while the vehicle 1 is actually operated.

According to the third example described so far, it is possible to further reduce blurring of the video image by causing the vehicle 1 to move along the moving route in which vibration becomes smaller.

### 3. Example of an Operation Process

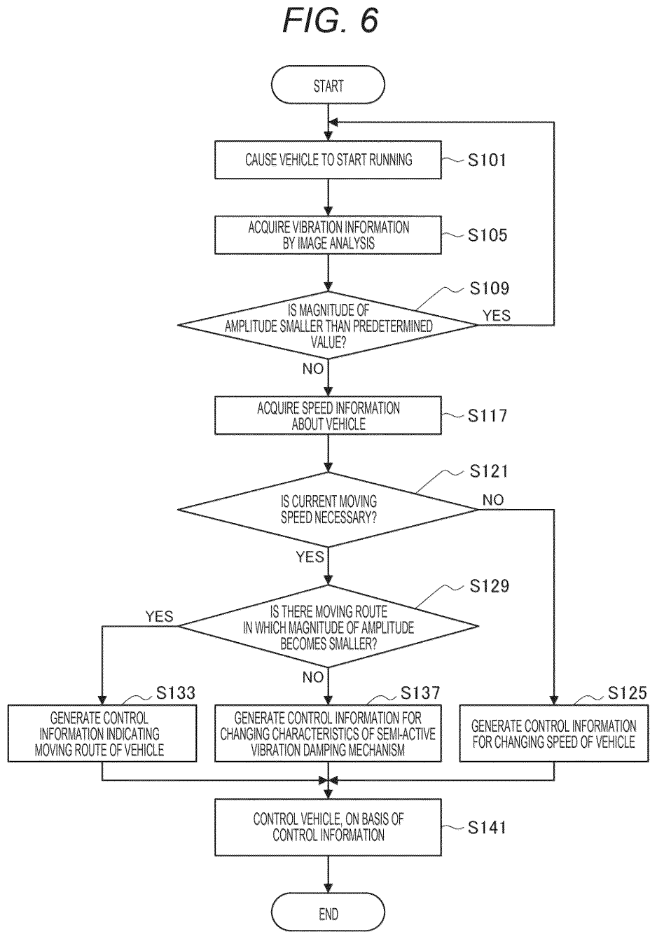

FIG. 6 is an explanatory diagram for explaining an example of an operation process to be performed by the information processing apparatus 110 according to the present embodiment. First, the generation unit 113 causes the vehicle 1 to start running in an environment (S101).

Subsequently, the analysis unit 111 acquires vibration information by performing image analysis on a video image obtained by the camera unit 5 (S105).

The generation unit 113 then determines whether the magnitude of the amplitude included in the vibration information is smaller than a predetermined value (S109). If the magnitude of the amplitude is smaller than the predetermined value (S109: Yes), the process returns to S101, and, if the magnitude of the amplitude is equal to or greater than the predetermined value (S109: No), the process proceeds to S117.

If the magnitude of the amplitude is equal to or greater than the predetermined value (S109: No), the information processing apparatus 110 acquires speed information about the wheels from the wheel encoder 520 (S117).

The generation unit 113 then determines whether the current moving speed is the necessary speed (S121). If the current moving speed is not the necessary speed (S121: No), the process proceeds to S125. If the current moving speed is the necessary speed (S121: Yes), the process proceeds to S129.

If the current moving speed is not the necessary speed (S121: No), the generation unit 113 generates control information for changing the speed of the vehicle 1 (S125).

If the current moving speed is the necessary speed (S121: Yes), the generation unit 113 determines whether there is a moving route in which the magnitude of the amplitude becomes smaller (S129). If there is a moving route in which the magnitude of the amplitude becomes smaller (S129: Yes), the process proceeds to S133. If there are no moving routes in which the magnitude of the amplitude becomes smaller (S129: No), the process proceeds to S137.

If there is a moving route in which the magnitude of the amplitude becomes smaller (S129: Yes), the generation unit 113 generates control information indicating the moving route of the vehicle 1 (S133).

If there are no moving routes in which the magnitude of the amplitude becomes smaller (S129: No), the generation unit 113 generates control information for changing the characteristics of the semi-active vibration damping mechanism 120 (S137).

The generation unit 113 then controls the operation of the vehicle 1 on the basis of the generated control information (S141), and the information processing apparatus 110 according to the present disclosure ends the operation process. Note that, in a case where the control information generated by the generation unit 113 is control information for changing the speed of the vehicle 1 or control information indicating the moving route of the vehicle 1, the generation unit 113 may control the operation of the vehicle 1 by outputting the control information to the wheel unit 50 (more specifically, to the motor 510). Further, in a case where the control information generated by the generation unit 113 is control information for changing the characteristics of the semi-active vibration damping mechanism 120, the generation unit 113 may control the operation of the vehicle 1 by outputting the control information to the semi-active vibration damping mechanism 120.

Note that, in the example of the operation process described above, the determination as to the generation of control information is performed, with the priority order being the first example (changing of speed), the third example (instruction regarding a moving route), and the second example (changing of characteristics of the semi-active vibration damping mechanism 120). However, the priority order is not limited to the example shown in FIG. 6. For example, the second example or the third example may have the highest priority.

### 4. Modifications

There are cases where the characteristics of the vibration to be generated in the camera unit 5 vary depending on the state of the vehicle 1 or the environment in which the vehicle 1 is moving. Such vibration characteristics can be predicted in advance in some cases, with the use of model information and environmental information about the vehicle 1. For example, as for the characteristics of vibration, there are cases where the cycles and the features of vibration can be predicted from the shape of the wheels or the shape of the road surface.

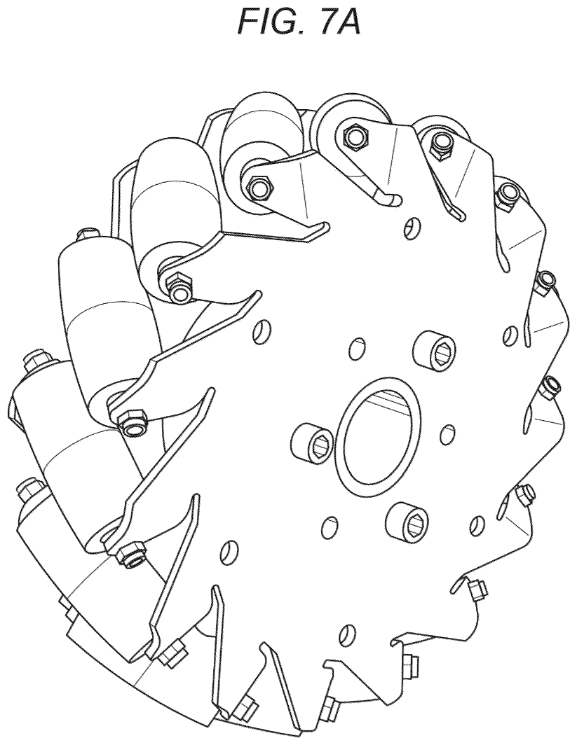

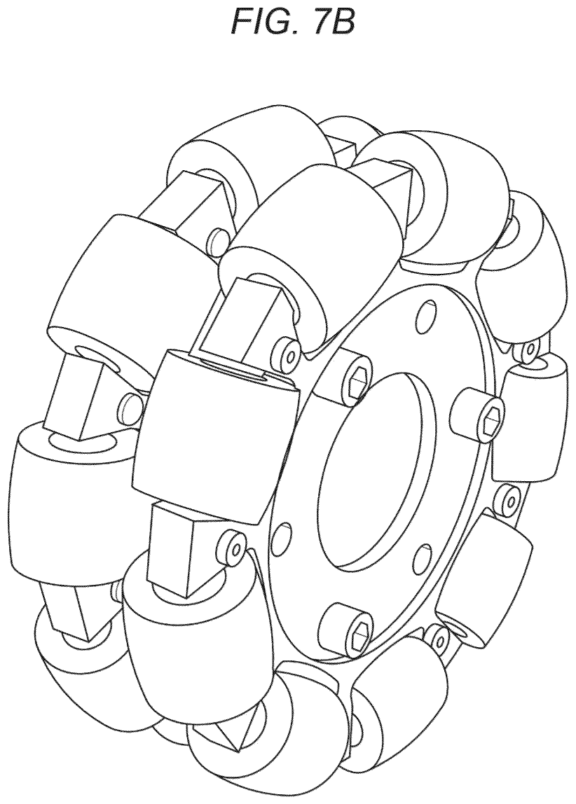

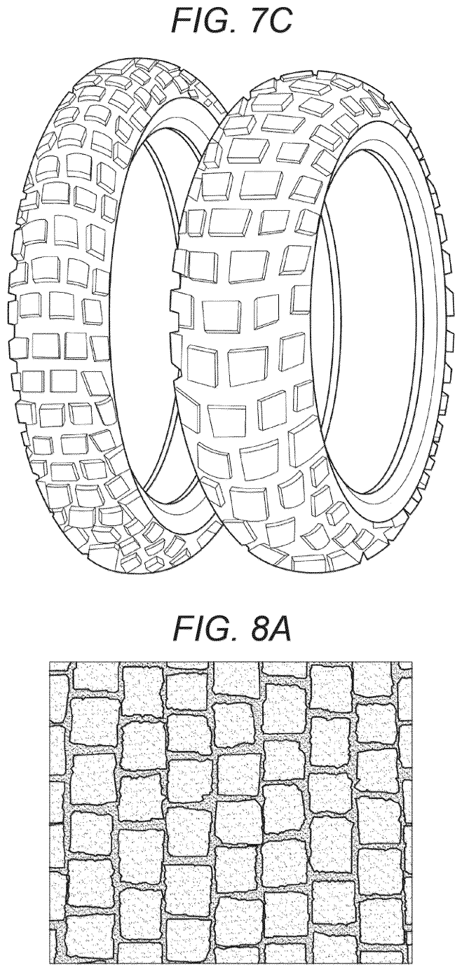

FIGS. 7A, 7B, and 7C are explanatory diagrams for explaining specific examples of shapes of the wheels of the vehicle 1. For example, there are cases where the wheels of the vehicle 1 are Mecanum wheels as shown in FIG. 7A. For example, in a case where the vehicle 1 travels straight or laterally on a flat road surface (or a road surface with fewer irregularities) with Mecanum wheels, vibration having a frequency that is a multiple of the value obtained by multiplying the rotation speed of the wheels by the number of barrels per wheel is strongly generated. Further, in the case of movement accompanied by rotation of Mecanum wheels, periodic vibration is generated depending on a difference in speed of the wheels.

In view of this, the generation unit 113 may generate control information to be used for vibration damping by utilizing the characteristics of vibration related to such wheel information (indicating that the type of the wheels is Mecanum wheel, for example).

Further, although an example in which the type of the wheels is Mecanum wheel has been described, the type of the wheels is not necessarily Mecanum wheel. For example, the type of the wheels may be omni wheel as shown in FIG. 7B, or may be normal wheel as shown in FIG. 7C.

The generation unit 113 may then generate control information to be used for vibration damping, on the basis of information about the wheels, such as the position and the number of irregularities, the material of the wheels, or the postures of the wheels, for example.

Also, the generation unit 113 may learn the relationship between the information about the wheels and the vibration to be generated in the wheels, and generate an estimation model. The generation unit 113 may then generate control information to be used for vibration damping, on the basis of the information about the wheels of the vehicle 1 and the estimation model.

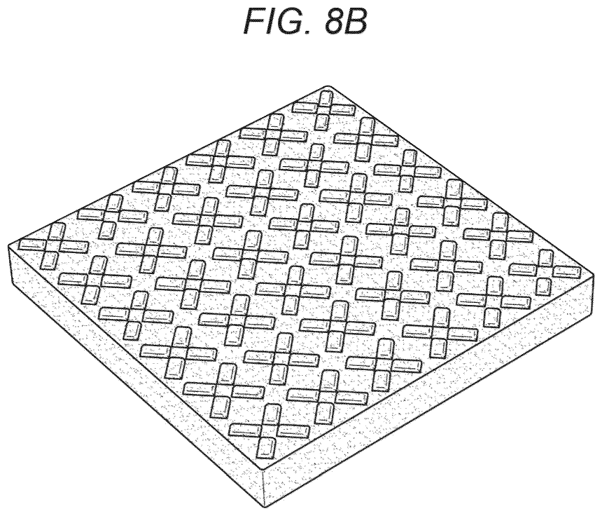

FIGS. 8A and 8B are explanatory diagrams for explaining specific examples of shapes of road surfaces in an environment in which the vehicle 1 moves. There are cases where, as well as the positions of the irregularities of the wheels, irregularities are present on the road surface. For example, between the road surface shown in FIG. 8A and the road surface shown in FIG. 8B, the vibration to be generated in the wheels may be different due to the differences in the positions and intervals of the grooves and protrusions, and the state of various road surfaces such as the material.

For example, the generation unit 113 may learn the relationship between the information about the road surface and the vibration to be generated in the wheels, and generate an estimation model. The generation unit 113 may then generate control information to be used for vibration damping, on the basis of the information about the road surface on which the vehicle 1 is moving and the estimation model.

Also, the characteristics of vibration to be generated in the camera unit 5 might vary depending on the material and the weight of the camera unit 5 mounted on the vehicle 1. For example, the resonance frequency can be estimated from information about the camera unit 5, such as the material and the weight of the camera unit 5, and the spring constant of the vibration damping mechanism. Accordingly, with the use of information about the camera unit 5, it is possible to perform various settings for damping vibration before actual operation of the vehicle 1.

For example, the generation unit 113 may estimate the resonance frequency on the basis of the information about the camera, and set the characteristics of the semi-active vibration damping mechanism 120 or the speed of the vehicle 1 so as to be out of a predetermined range from the estimated resonance frequency.

According to the modifications as described above, it is possible to predict the characteristics of vibration to be generated in the camera unit 5, using information about the wheels, information about the road surface, or information (the material, the weight, or the like) about the camera unit 5. As a result, it is possible to omit the process to be performed by the analysis unit 111 to acquire the frequency response information on the basis of the video image obtained by the vehicle 1 moving while imaging the inside of the environment prior to actual operation.

Note that, in a case where an error between the vibration characteristics actually obtained and the predicted vibration characteristics exceeds an allowable value when the vehicle 1 is actually operated, the analysis unit 111 may acquire the frequency response information. In this case, the generation unit 113 may generate control information, on the basis of the newly acquired frequency response information.

### 5. Example of a Hardware Configuration

The embodiment of the present disclosure has been described so far. The information processing described above is implemented by cooperation of software and the hardware of the information processing apparatus 110 described below.

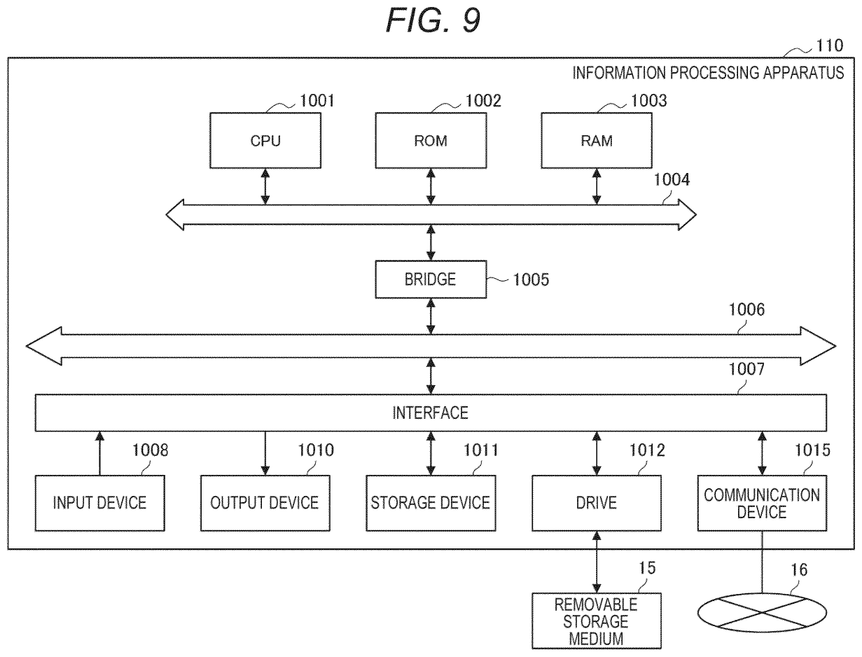

FIG. 9 is a block diagram showing the hardware configuration of the information processing apparatus 110. The information processing apparatus 110 includes a central processing unit (CPU) 1001, a read only memory (ROM) 1002, a random access memory (RAM) 1003, and a host bus 1004. Also, the information processing apparatus 110 includes a bridge 1005, an external bus 1006, an interface 1007, an input device 1008, an output device 1010, a storage device (HDD) 1011, a drive 1012, and a communication device 1015.

The CPU 1001 functions as an arithmetic processing device and a control device, and controls the overall operation in the information processing apparatus 110 in accordance with various programs. Furthermore, the CPU 1001 may be a microprocessor. The ROM 1002 stores programs, operation parameters, and the like to be used by the CPU 1001. The RAM 1003 temporarily stores the programs to be used in execution by the CPU 1001, parameters that change as appropriate in the execution, and the like. These components are connected to one another by the host bus 1004 formed with a CPU bus or the like. The functions of the analysis unit 111, the generation unit 113 and the like described with reference to FIG. 2 can be implemented by cooperation of the CPU 1001, the ROM 1002, the RAM 1003, and software.

The host bus 1004 is connected to the external bus 1006 such as a peripheral component interconnect/interface (PCI) bus via the bridge 1005. Note that the host bus 1004, the bridge 1005, and the external bus 1006 are not necessarily configured separately, and the functions thereof may be mounted on a single bus.

The input device 1008 includes an input means that allows a user to input information, such as a mouse, a keyboard, a touch panel, buttons, a microphone, a switch, and a lever, and an input control circuit that generates an input signal on the basis of an input by the user and outputs the input signal to the CPU 1001. By operating the input device 1008, the user of the information processing apparatus 110 can input various kinds of data to the information processing apparatus 110, or instruct the information processing apparatus 110 to perform a processing operation.

The output device 1010 includes display devices such as a liquid crystal display device, an OLED device, and a lamp, for example. Further, the output device 1010 includes audio output devices such as a speaker and headphones. The output device 1010 outputs reproduced content, for example. Specifically, the display devices display various kinds of information such as reproduced video data as text or images. On the other hand, the audio output devices convert reproduced audio data and the like into sound, and outputs the sound.

The storage device 1011 is a device for data storage. The storage device 1011 may include a storage medium, a recording device that records data on the storage medium, a reading device that reads data from the storage medium, and a deletion device that deletes data recorded on the storage medium. The storage device 1011 is formed with a hard disk drive (HDD), for example. The storage device 1011 drives a hard disk, and stores programs to be executed by the CPU 1001 and various kinds of data.

The drive 1012 is a reader/writer for a storage medium, and is built in or externally attached to the information processing apparatus 110. The drive 1012 reads out information recorded on a removable storage medium 1018 mounted thereon, such as a magnetic disc, an optical disc, a magneto-optical disc, or a semiconductor memory, and outputs the information to the RAM 1003. Also, the drive 1012 can write information into the removable storage medium 15.

The communication device 1015 is a communication interface formed with a communicating device or the like for connection to a network 16, for example. Alternatively, the communication device 1015 may be a wireless LAN communication device, a long term evolution (LTE) communication device, or a wire communication device that performs wired communication.

### 6. Supplementary Notes

A preferred embodiment of the present disclosure has been described in detail with reference to the accompanying drawings, but the present disclosure is not limited to such an example. It is apparent that a person having ordinary knowledge in the technical field to which the present disclosure belongs can devise various examples of changes or modifications within the scope of the technical idea described in the claims, and it will be naturally understood that such examples also belong to the technical scope of the present disclosure.

For example, a display device may display information related to control information generated by the generation unit 113. More specifically, in a case where the control information generated by the generation unit 113 includes lowering of the speed, a display device included in the vehicle 1 may display information as an instruction to lower the speed of the vehicle 1. The operator of the vehicle 1 may then control the operation of the vehicle 1, on the basis of the information displayed by the display device.

Further, the camera unit 5, the vehicle body unit 10, and the wheel unit 50 may not necessarily include all of the components shown in FIG. 2. For example, the camera unit 5 does not necessarily include the correction unit 7.

Furthermore, in an example described above in the present specification, the generation unit 113 generates control information to be used for vibration damping, using the frequency response information acquired prior to an actual operation. However, the generation unit 113 does not necessarily acquire the frequency response information in advance. For example, the generation unit 113 may generate control information to be used for vibration damping while acquiring the relationship between the magnitude of the amplitude and the frequency during an actual operation. Further, in a case where the frequency response information has not been acquired in advance, the generation unit 113 may continue to generate control information for lowering the speed of the vehicle 1 until the magnitude of the amplitude becomes smaller than a predetermined value.

Also, there are cases where the magnitude of the amplitude generated in the camera unit 5 is equal to or greater than a predetermined value in a situation such as when the vehicle 1 comes into contact with an obstacle on a road surface. In such a case, the generation unit 113 may regard the temporary increase in amplitude as noise, and does not need to generate the control information to be used for vibration damping. Also, the generation unit 113 may generate control information to be used for vibration damping, when the time during which the magnitude of the amplitude is equal to or greater than the predetermined value continues for a certain period or longer. Here, the noise determination is not limited to the time-based method as described above. For example, the analysis unit 111 may detect an obstacle (a large stone or the like, for example) on the road surface, using a known method. When it is estimated that a wheel of the vehicle 1 has come into contact with the detected obstacle, the generation unit 113 may then determine that the vibration generated in the vehicle 1 is noise.

Further, when the magnitude of the amplitude is equal to or greater than the predetermined value, the generation unit 113 may generate control information for changing the posture of the vehicle 1 as the control information to be used for vibration damping. For example, in a case where the connecting portion between the vehicle body unit 10 and the camera unit 5 is movable, the generation unit 113 may generate control information for changing the posture of the connecting portion.

Furthermore, in the example described above in the present specification, the vehicle 1 includes the information processing apparatus 110. However, the information processing apparatus 110 according to the present disclosure may be disposed at a place different from the vehicle 1. Also, the information processing apparatus 110 may be mounted on the camera unit 5 or the wheel unit 50, instead of the vehicle body unit 10 of the vehicle 1.

Furthermore, the respective steps in the process to be performed by the information processing apparatus 110 in the present specification are not necessarily carried out in chronological order shown as the flowchart. For example, the respective steps in the process to be performed by the information processing system may be carried out in an order different from the order shown as the flowchart or in parallel.

Furthermore, it is also possible to create a computer program for causing hardware in the information processing apparatus 110, such as a CPU, a ROM, and a RAM, to implement functions equivalent to those of the respective components of the information processing apparatus 110 described above. Also, a non-transitory storage medium storing the computer program is also provided.

Furthermore, the effects described in the present specification are merely exemplary or illustrative, but are not restrictive. That is, the technology according to the present disclosure can exhibit some other effects apparent to those skilled in the art from the description in the present specification, in addition to the effects described above or instead of the effects described above.

Note that the following configurations also fall within the technical scope of the present disclosure.

(1)

An information processing apparatus including:
an acquisition unit that acquires vibration information regarding vibration generated in a camera mounted on a mobile body, the vibration information being based on a video image captured by imaging performed by the camera; and
a generation unit that generates control information to be used for damping the vibration, on the basis of the vibration information acquired by the acquisition unit.
   (2)

The information processing apparatus according to (1), in which
the generation unit generates the control information, on the basis of a fact that a magnitude of the vibration does not satisfy a predetermined criterion.
   (3)

The information processing apparatus according to (2), in which
the magnitude of the vibration includes a magnitude of an amplitude, and
the magnitude of the vibration not satisfying the predetermined criterion includes the magnitude of the amplitude being equal to or greater than a predetermined value.
   (4)

The information processing apparatus according to (3), in which,
when the magnitude of the amplitude is equal to or greater than the predetermined value, the generation unit generates the control information for changing a speed of the mobile body.
   (5)

The information processing apparatus according to (4), in which,
on the basis of a relationship between the magnitude of the amplitude and frequency, the generation unit generates the control information for changing the speed of the mobile body.
   (6)

The information processing apparatus according to (5), in which
the relationship between the magnitude of the amplitude and the frequency includes a resonance frequency at which the magnitude of the amplitude is equal to or greater than the predetermined value.
   (7)

The Information processing apparatus according to (6), in which
the generation unit generates the control information for changing the speed of the mobile body so as to be out of a predetermined range from the resonance frequency.
   (8)

The information processing apparatus according to any one of (3) to (7), in which
the mobile body includes a semi-active vibration damping mechanism, and,
when the magnitude of the amplitude is equal to or greater than the predetermined value, the generation unit generates the control information for changing characteristics of the semi-active vibration damping mechanism.
   (9)

The information processing apparatus according to (8), in which
the semi-active vibration damping mechanism includes a variable spring, and
the generation unit generates the control information for changing an elastic force of the variable spring.
   (10)

The information processing apparatus according to (8) or (9), in which
the semi-active vibration damping mechanism includes a variable damper, and
the generation unit generates the control information for changing a resistance force of the variable damper.
   (11)

The information processing apparatus according to any one of (3) to (10), in which,
on the basis of a relationship between each area of a plurality of areas included in map information about an environment in which the mobile body is moving and the magnitude of the vibration,
the generation unit generates the control information indicating a moving route of the mobile body.
   (12)

The information processing apparatus according to (11), in which,
on the basis of location information about the mobile body, the generation unit generates the control information indicating the moving route of the mobile body.
   (13)

The information processing apparatus according to (12), in which
the generation unit generates the control information indicating the moving route in which the magnitude of the amplitude is smaller than the predetermined value.
   (14)

The information processing apparatus according to any one of claims (1) to (13), in which
the mobile body includes a vehicle.
   (15)

The information processing apparatus according to (14), in which,
on the basis of information about a wheel of the vehicle, the generation unit generates the control information to be used for damping the vibration.
   (16)

The information processing apparatus according to (14) or (15), in which,
on the basis of information about a road surface on which the vehicle is moving, the generation unit generates the control information to be used for damping the vibration.
   (17)

The information processing apparatus according to any one of (14) to (16), in which,
on the basis of information about the camera mounted on the mobile body, the generation unit generates the control information to be used for damping the vibration.
   (18)

The information processing apparatus according to (1), in which
the information processing apparatus is mounted on the mobile body.
   (19)

An information processing method implemented by a computer, the information processing method including:
acquiring vibration information regarding vibration generated in a camera mounted on a mobile body, the vibration information being based on a video image captured by imaging performed by the camera; and
generating control information to be used for damping the vibration, on the basis of the acquired vibration information.
   (20)

A program for causing a computer to implement:
an acquisition function to acquire vibration information regarding vibration generated in a camera mounted on a mobile body, the vibration information being based on a video image captured by imaging performed by the camera; and
a generation function to generate control information to be used for damping the vibration, on the basis of the vibration information acquired by the acquisition function.

1. An information processing apparatus comprising:
an acquisition unit that acquires vibration information regarding vibration generated in a camera mounted on a mobile body, the vibration information being based on a video image captured by imaging performed by the camera; and
a generation unit that generates control information to be used for damping the vibration, on a basis of the vibration information acquired by the acquisition unit.

2. The information processing apparatus according to claim 1, wherein
the generation unit generates the control information, on a basis of a fact that a magnitude of the vibration does not satisfy a predetermined criterion.

3. The information processing apparatus according to claim 2, wherein
the magnitude of the vibration includes a magnitude of an amplitude, and
the magnitude of the vibration not satisfying the predetermined criterion includes the magnitude of the amplitude not being smaller than a predetermined value.

4. The information processing apparatus according to claim 3, wherein,
when the magnitude of the amplitude is not smaller than the predetermined value, the generation unit generates the control information for changing a speed of the mobile body.

5. The information processing apparatus according to claim 4, wherein,
on a basis of a relationship between the magnitude of the amplitude and frequency, the generation unit generates the control information for changing the speed of the mobile body.

6. The information processing apparatus according to claim 5, wherein
the relationship between the magnitude of the amplitude and the frequency includes a resonance frequency at which the magnitude of the amplitude is not smaller than the predetermined value.

7. The information processing apparatus according to claim 6, wherein
the generation unit generates the control information for changing the speed of the mobile body so as to be out of a predetermined range from the resonance frequency.

8. The information processing apparatus according to claim 3, wherein
the mobile body includes a semi-active vibration damping mechanism, and,
when the magnitude of the amplitude is not smaller than the predetermined value, the generation unit generates the control information for changing characteristics of the semi-active vibration damping mechanism.

9. The information processing apparatus according to claim 8, wherein
the semi-active vibration damping mechanism includes a variable spring, and
the generation unit generates the control information for changing an elastic force of the variable spring.

10. The information processing apparatus according to claim 8, wherein
the semi-active vibration damping mechanism includes a variable damper, and
the generation unit generates the control information for changing a resistance force of the variable damper.

11. The information processing apparatus according to claim 3, wherein,
on a basis of a relationship between each area of a plurality of areas included in map information about an environment in which the mobile body is moving and the magnitude of the vibration, the generation unit generates the control information indicating a moving route of the mobile body.

12. The information processing apparatus according to claim 11, wherein,
on a basis of location information about the mobile body, the generation unit generates the control information indicating the moving route of the mobile body.

13. The information processing apparatus according to claim 12, wherein
the generation unit generates the control information indicating the moving route in which the magnitude of the amplitude is smaller than the predetermined value.

14. The information processing apparatus according to claim 3, wherein
the mobile body includes a vehicle.

15. The information processing apparatus according to claim 14, wherein,
on a basis of information about a wheel of the vehicle, the generation unit generates the control information to be used for damping the vibration.

16. The information processing apparatus according to claim 15, wherein,
on a basis of information about a road surface on which the vehicle is moving, the generation unit generates the control information to be used for damping the vibration.

17. The information processing apparatus according to claim 16, wherein,
on a basis of information about the camera mounted on the mobile body, the generation unit generates the control information to be used for damping the vibration.

18. The information processing apparatus according to claim 1, wherein
the information processing apparatus is mounted on the mobile body.

19. An information processing method implemented by a computer, the information processing method comprising:
acquiring vibration information regarding vibration generated in a camera mounted on a mobile body, the vibration information being based on a video image captured by imaging performed by the camera; and
generating control information to be used for damping the vibration, on a basis of the acquired vibration information.

20. A program for causing a computer to implement:
an acquisition function to acquire vibration information regarding vibration generated in a camera mounted on a mobile body, the vibration information being based on a video image captured by imaging performed by the camera; and
a generation function to generate control information to be used for damping the vibration, on a basis of the vibration information acquired by the acquisition function.
